(19) United States
(12) Patent Application Publication
(10) Pub. No.: US 2026/0245484 A1
(43) Pub. Date: Aug. 20, 2026

(54) SHIPPING LABEL DISPLAY FOR SHIPPING CONTAINER

(71) Applicant: Federal Express Corporation, Memphis, TN (US)

(72) Inventors: Kyle Jacob McCarter, Memphis, TN (US); Guillermo Isaac Valverde Toledo, Memphis, TN (US); Tyler Michael Kenney, Memphis, TN (US)

(21) Appl. No.: 19/539,416

(22) Filed: Feb. 13, 2026

Related U.S. Application Data
(60) Provisional application No. 63/758,834, filed on Feb. 14, 2025.

(51) Int. Cl. G09F 3/20; B65D 5/42

(52) U.S. Cl. CPC G09F 3/201; B65D 5/4233

(57) ABSTRACT

A document centering pocket for securely displaying shipping labels and other documents is disclosed. The pocket includes a base layer and a pocket frame attached along three edges, with a top edge unattached to allow document insertion. The pocket frame has opposing indented regions on its side edges that narrow the frame, creating a centering effect to keep inserted documents properly positioned. A removable transparent cover fits within the pocket frame to protect and display the document. The pocket can be used on shipping containers and includes features like a tapered internal shape and protrusions to further secure documents. The pocket prevents shifting of shipping labels during transit, ensuring critical information remains visible. Other embodiments are disclosed.

### CROSS-REFERENCE TO RELATED APPLICATIONS

This application claims the benefit under 35 U.S.C. § 119(e) of U.S. Patent Application No. 63/758,834, entitled “Shipping Label Display For Shipping Container,” filed February 14, 2025, which is incorporated herein by reference in its entirety.

### BACKGROUND

Shipping and logistics operations rely heavily on accurate and visible labeling of packages and containers. Traditional methods of attaching shipping labels to containers often face challenges that can disrupt the flow of goods through supply chains.

### SUMMARY

The present disclosure relates to a shipping label display that can be used with shipping containers, and can be used in other implementations to center documents to enable information on the documents to be visible.

In some implementations, a document centering pocket is provided with a base layer of material and a pocket frame attached to it. The pocket frame has a central aperture and is attached on three sides, leaving the top edge unattached. The side edges of the pocket frame have opposing indented regions that narrow the frame, which serve to center a document within the central aperture.

In some implementations, the document centering pocket includes a third indented region on the bottom edge of the pocket frame.

In some implementations, the document centering pocket further includes a removable plastic cover designed to fit within the pocket frame. This cover has indented regions that correspond to the shape of the pocket frame's indented regions.

In some implementations, a shipping container is provided with a wall and a pocket attached to its exterior side. The pocket has tapered sidewalls, a base with a protrusion, and a removable lip. A transparent display with a corresponding tapered shape and a recess fits into the pocket, creating a cavity to house a shipping label visible through the display.

In some implementations, the pocket of the shipping container has portions of different widths, with a first portion having a first width and a second portion having a second width that is different from the first width.

In some implementations, the shipping container includes a pair of shoulders separating the first portion and the second portion of the pocket, with each shoulder tapering from the first width to the second width on each of the pair of sidewalls to define the first shape.

In some implementations, the transparent display of the shipping container includes a third portion having a third width and a fourth portion having a fourth width, with the fourth width being smaller than the third width.

In some implementations, the third width of the transparent display corresponds to the first width of the pocket, and the fourth width corresponds to the second width of the pocket.

In some implementations, the transparent display includes a pair of shoulders separating the third portion and the fourth portion, with each shoulder tapering from the third width to the fourth width on the external surface to define the second shape.

In some implementations, the first width, second width, third width, and fourth width are sized to correspond to a width of the shipping label and to mitigate movement of the shipping label within the cavity.

In some implementations, the pocket of the shipping container is opaque.

In some implementations, the pair of sidewalls and the base of the pocket are fastened to the exterior side of the wall via stitching or an adhesive.

In some implementations, the shipping container further comprises a retention mechanism fastened to the lip to removably couple the lip to the exterior side of the wall and secure the shipping label inside the cavity.

In some implementations, the retention mechanism of the shipping container comprises Velcro or an adhesive.

In some implementations, a shipping label display is provided, comprising a pocket with tapered sidewalls and a base with a protrusion, along with a corresponding transparent display that fits into the pocket.

In some implementations, the pocket of the shipping label display includes a first portion and a second portion, with the first portion having a first width and the second portion having a second width that is different from the first width.

In some implementations, the shipping label display further comprises a pair of shoulders separating the first portion and the second portion of the pocket, with each shoulder tapering from the first width to the second width on each of the pair of sidewalls to define the first shape.

In some implementations, the transparent display of the shipping label display includes a third portion having a third width and a fourth portion having a fourth width, with the fourth width being smaller than the third width.

In some implementations, the third width of the transparent display corresponds to the first width of the pocket, and the fourth width corresponds to the second width of the pocket in the shipping label display.

In some implementations, the transparent display of the shipping label display includes a pair of shoulders separating the third portion and the fourth portion, with each shoulder tapering from the third width to the fourth width on the external surface to define the second shape.

In some implementations, a kit is provided that includes a pocket with tapered sidewalls and a base with a protrusion, a corresponding transparent display, and a temporary package. The pocket can be attached to the temporary package and later removed for use on a shipping container.

In some implementations, the means for coupling the pocket to the temporary package in the kit are an adhesive.

In some implementations, the pocket and the transparent display in the kit are configured to be removed from the temporary package and coupled to a shipping container.

The details of one or more implementations of the subject matter described in this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1A illustrates a shipping container with a pocket for displaying a document.

FIGS. 1B and 1C illustrate the document in shifted positions within the pocket.

FIG. 2 illustrates a document centering pocket coupled to a shipping container.

FIG. 3 illustrates an isolated view of the pocket.

FIG. 4 illustrates a transparent display configured to fit within the pocket.

FIGS. 5A and 5B illustrate the document centered within the pocket, with information visible.

FIG. 6 shows an alternate pocket.

FIG. 7 depicts a kit including the pocket, transparent display, and a temporary package.

FIG. 8A illustrates the pocket attached to an armband.

FIG. 8B shows a user wearing the armband with the attached pocket.

Like reference numbers and designations in the various drawings indicate like elements.

### DETAILED DESCRIPTION

In traditional supply chain operations utilizing containers, the conventional methods of attaching shipping labels can significantly impede the flow of goods. Typically, these labels are affixed using adhesive stickers or inserted into plastic sleeves attached to the container. This approach introduces several disruptive elements into the supply chain process. The time-consuming task of manually removing old labels at each destination point creates delays, while the repeated application and removal of adhesive labels can gradually damage the container's surface, potentially compromising its structural integrity or appearance. Furthermore, incomplete removal of old labels or improper coverage can lead to sorting errors and misrouted goods in subsequent shipments. The challenges associated with label management can also result in outdated or incorrect information remaining on containers, causing inventory discrepancies and inefficient asset tracking. These issues collectively contribute to increased labor costs throughout the supply chain, as additional time and effort are required to manage traditional labeling systems. Moreover, the constant production and disposal of adhesive labels raise environmental concerns due to the generation of waste. Consequently, these factors combine to decelerate container turnaround times, elevate the risk of errors, and introduce unnecessary costs into the supply chain process, ultimately disrupting the seamless movement of goods from their point of origin to their final destination.

Another common issue with shipping labels is the shifting or obscuring of the shipping labels during transit. For example, documents placed in conventional pockets can move, potentially hiding critical information such as barcodes or addresses. This can lead to delays, misrouting, or the need for manual intervention to reposition labels for scanning.

Another challenge is the wear and tear on labels exposed to harsh shipping environments. Without proper protection, labels can become damaged or illegible, compromising the ability to track and process packages efficiently.

Furthermore, the increasing use of reusable shipping containers in eco-friendly supply chains necessitates a labeling solution that allows for easy updating of shipping information without damaging the container itself.

Previous attempts to address these issues have included adhesive label holders and rigid plastic sleeves. However, these solutions often fall short in terms of durability, ease of use, or ability to keep documents centered and visible.

Implementations disclosed herein are directed to improved document display systems that can securely hold and protect shipping labels while ensuring they remain centered and visible throughout the shipping process. Implementations disclosed herein are adaptable to various container types and sizes, and are reusable to align with sustainable shipping practices.

The implementations disclosed herein provide a secure, adaptable, and user-friendly solution for displaying shipping documents and other important information on reusable containers and in various other applications.

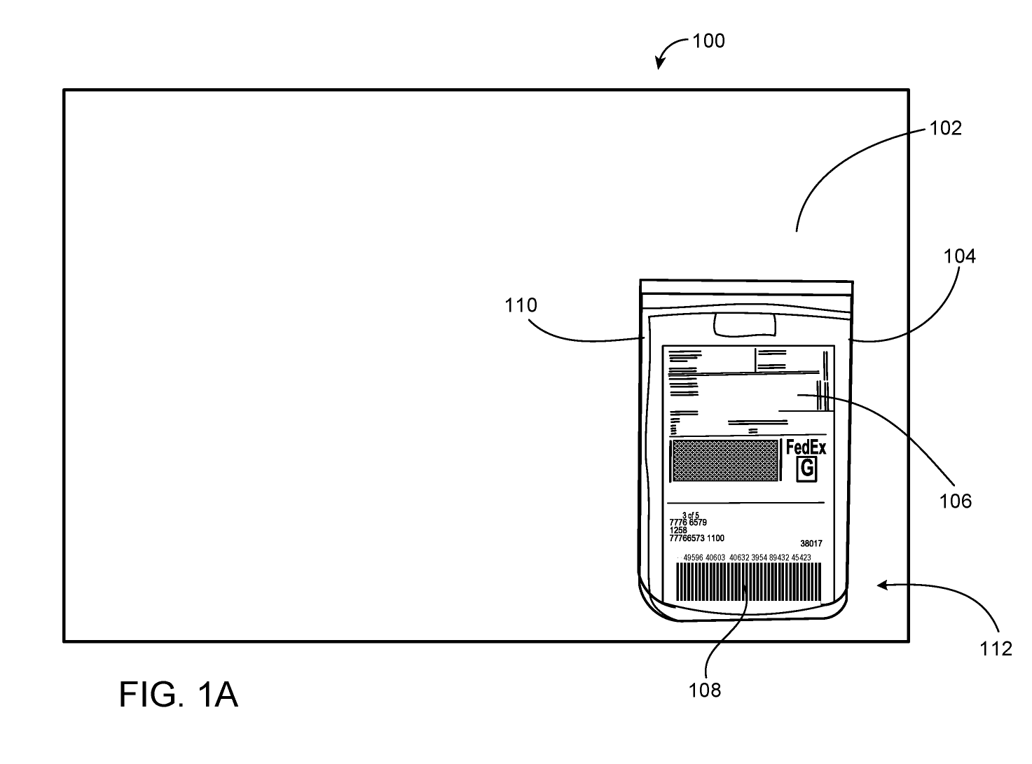

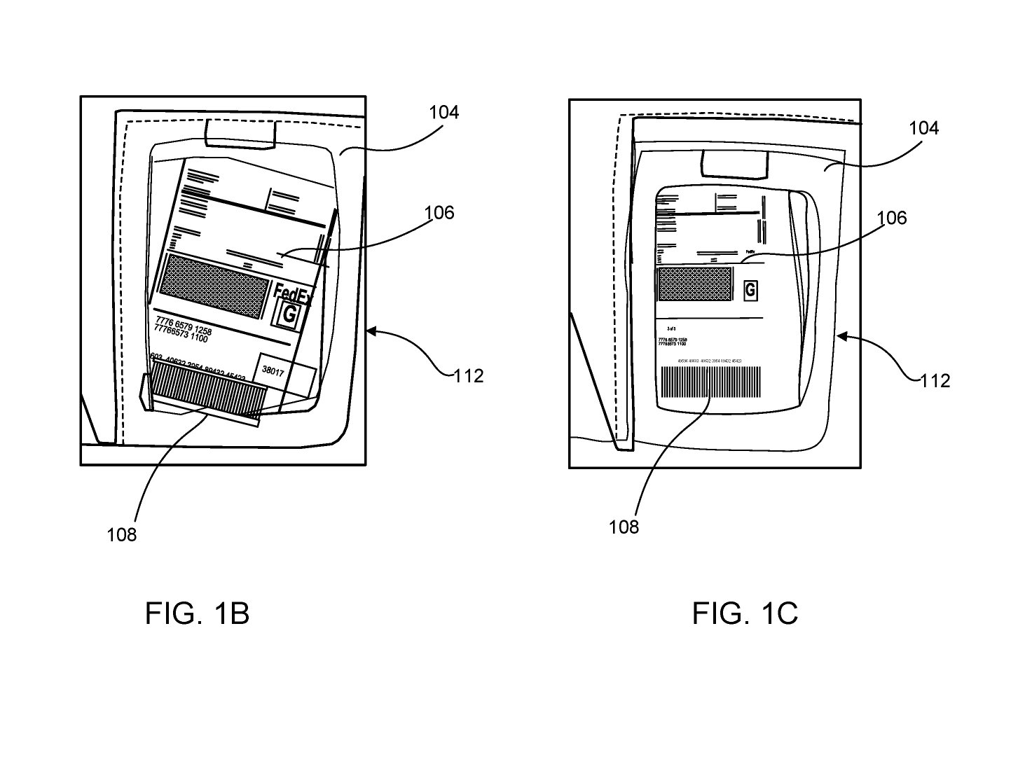

FIG. 1A illustrates a shipping container 100. The shipping container 100 includes an exterior wall 102. The exterior wall 102 defines the outside of the reusable shipping container 100 and can be the walls, top cover, or bottom surface of the shipping container 100. The exterior wall 102 (e.g., exterior surfaces) define an interior wall that defines a storage portion that can store items for shipping in the container 100. For example, the storage portion can store items for transport. In some implementations, the shipping container 100 is a reusable shipping container. However, the shipping container 100 can be any type of container that includes a label for displaying information. This may include, but is not limited to, cardboard boxes, plastic totes, wooden crates, metal containers, or fabric bags. The container may be designed for single-use or multiple uses, depending on the specific application and requirements.

Reusable shipping containers offer several advantages, such as reduced waste, cost savings over time, and increased durability. These containers may be made from materials like high-density polyethylene (HDPE), polypropylene, or reinforced fabrics that can withstand repeated use and various environmental conditions.

The size and shape of the shipping container 100 can vary widely based on the intended contents and shipping method. It may range from small parcels suitable for individual items to large intermodal containers used in global logistics. Regardless of its dimensions, the key feature is the presence of a label that can effectively convey necessary information throughout the shipping process.

The shipping container 100 includes a pocket 104 for housing and displaying a document 106. The document 106 includes information 108 that enables the shipping container 100 to be transported from one destination to another. The information 108 can include addresses, barcodes, QR codes, or any other type of information that can be utilized to handle the shipping container 100 during transit operations. For example, the information 108 can be a bar code that is scanned at various points in a transit operation by either a machine or an individual. In some examples, the document 106 is a shipping label. The shipping label may have specific parameters to ensure efficient operation through shipping systems. For instance, all barcodes on the shipping label should meet or exceed requirements specified in the "ANSI X3. 182 Barcode Print Quality Guidelines" and be specific to the Uniform Symbology Specification for each symbology system type. These specifications ensure that all scanning systems can accurately and reliably decode the barcode information.

However, the information 108 can also be presented in various other formats, including visuals, images, displays, and more advanced technologies. For example, the document 106 could incorporate high-resolution images or graphics that visually represent shipping routes or handling instructions. QR codes can be used not only for basic shipping information but also to link to real-time tracking data or detailed package contents.

Furthermore, the pocket 104 could be designed to accommodate small electronic displays. These displays could show dynamic information such as current location, estimated delivery time, or special handling instructions that can be updated throughout the shipping process. This could be particularly useful for packages requiring temperature control or time-sensitive deliveries.

The document 106 could also incorporate more advanced identification technologies. For example, RFID tags could be embedded in the document or the pocket itself, allowing for contactless scanning and tracking.

The pocket 104 includes a transparent display 110 that enables the information 108 to be displayed and accessed while the document 106 is positioned in the pocket 104. The transparent display 110 is a plastic insert that is coupled to the pocket 104 to define a viewable area 112 for the document 106, in particular, the information 108.

Turning to FIGS. 1B and 1C, the document 106 is illustrated in various positions that occur during shipping. For example, in the illustrated embodiment of FIG. 1B and 1C the document 106 has shifted such that the information 108 is blocked by a portion of the pocket 104. In this example, the information 108 is a barcode. As such, in these scenarios, the barcode cannot be read by a machine. This hinders the shipping container 100 from being properly handled during transit. To access the information 108, in the examples of FIGS. 1B and 1C, an individual would have to access the pocket 104 to reposition the document 106 so that the information 108 is clearly visible within the viewable area 112 so that the shipping container 100 can be properly processed.

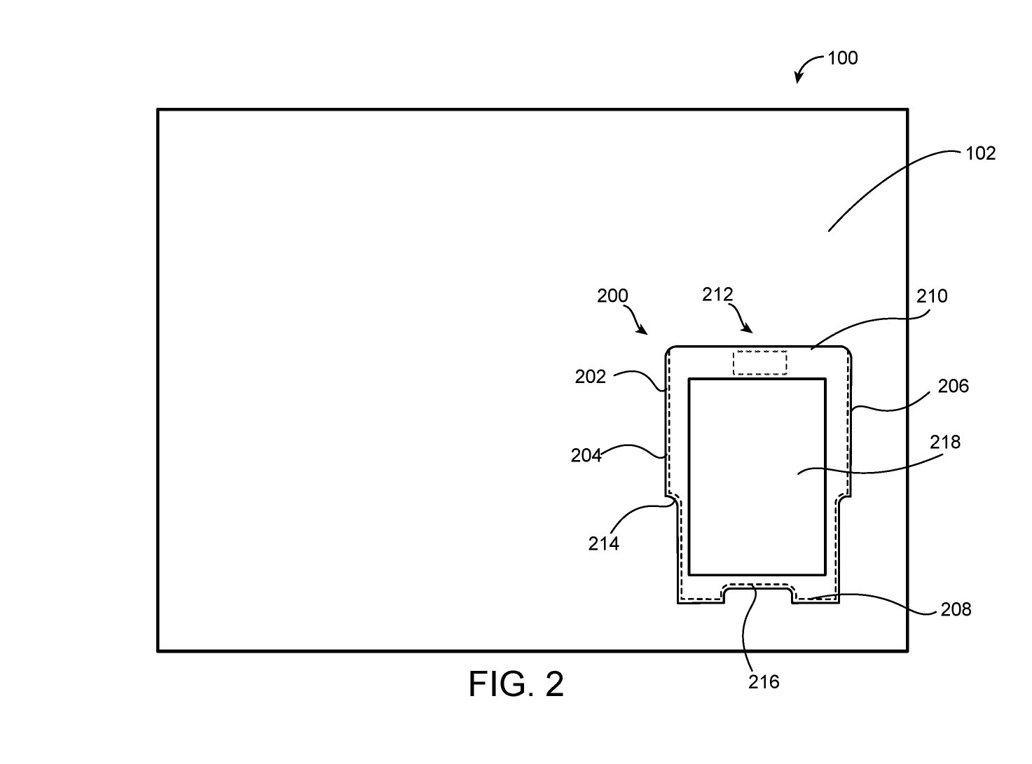

To mitigate the issues of the document of FIGS. 1B and 1C, a document centering system is disclosed. FIG. 2 illustrates a document centering pocket 200. The document centering pocket 200 comprises a base layer of material (e.g., the exterior wall 102) and a pocket frame 202 attached to the base layer of material 102 along a first side edge 204, a second side edge 206, and a bottom edge 208 of the pocket frame 202. A top edge 210 of the pocket frame 202 is un-attached to the base layer of material 102. The pocket frame 202 defines a central aperture 212 therethrough.

The first side edge 204 and the second side edge 206 each include opposing indented regions 214 where the pocket frame 202 narrows such that a distance between an outer perimeter of the pocket frame and an inner edge of the central aperture 212 is less than in other regions. The opposing indented regions 214 serve to center the document 106 within the central aperture 212 between the first side edge 204 and the second side edge 206.

In some embodiments, the bottom edge 208 includes a third indented region 216. This third indented region 216 can further assist in centering the document 106 within the central aperture 212.

The document centering pocket 200 may further include a removable plastic cover 218 configured to fit within the pocket frame 202 such that a perimeter region of the removable plastic cover 218 is captured between the base layer of material 102 and the pocket frame 202. The removable plastic cover 218 comprises opposing indented regions that correspond with a shape of the opposing indented regions 214 of the pocket frame 202. This correspondence in shape helps maintain the centering effect on the document 106.

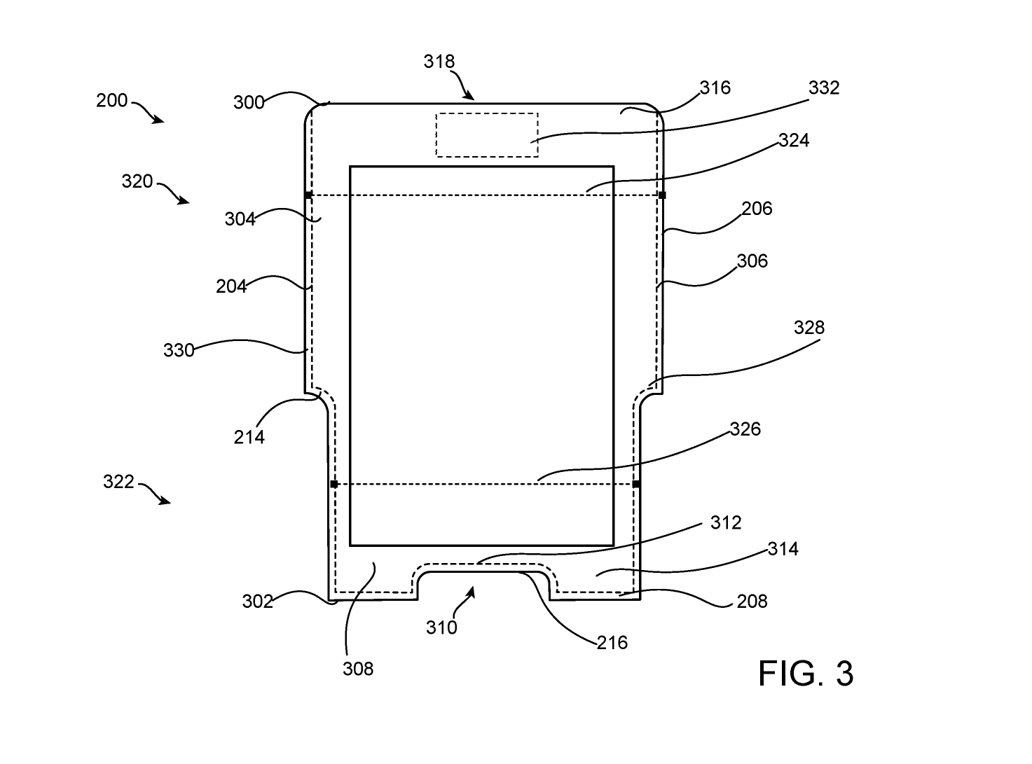

FIG. 3 illustrates a pocket 200 that can be used in the shipping container 100. The pocket 200 includes a first end 300 and a second end 302. A pair of sidewalls including a first sidewall 304 and a second sidewall 306 extend from the first end 300 to the second end 302. The pair of sidewalls 304, 306 are fastened to the exterior side of the wall 102.

A base 308 is positioned at the second end 302, between the pair of sidewalls 304, 306 to define a perimeter of the pocket. The base 308 is fastened to the exterior side of the wall 102 and includes a first recess 310 that defines a protrusion 312 on an interior side 314 of the base 308.

A lip 316 is positioned at the first end 300 of the pocket and is configured to be removably coupled to the exterior side of the wall 102. An internal surface is defined by the pair of sidewalls 304, 306 and the base 308. This internal surface includes a first shape that tapers from the first end 300 towards the second end 302 of the pocket.

An opening 318 is defined by the pair of sidewalls 304, 306, the base 308, and the lip 316. The opening 318 is further defined by the exterior side of the wall 102.

The pocket 200 includes a first portion 320 and a second portion 322. The first portion 320 has a first width 324 and the second portion 322 has a second width 326, where the second width 326 is different than the first width 324.

The opposing indented regions 214 can be a pair of shoulders 328 separating the first portion 320 and the second portion 322. Each shoulder 328 tapers from the first width 324 to the second width 326 on each of the pair of sidewalls 304, 306 to define the first shape as illustrated in FIG. 3.

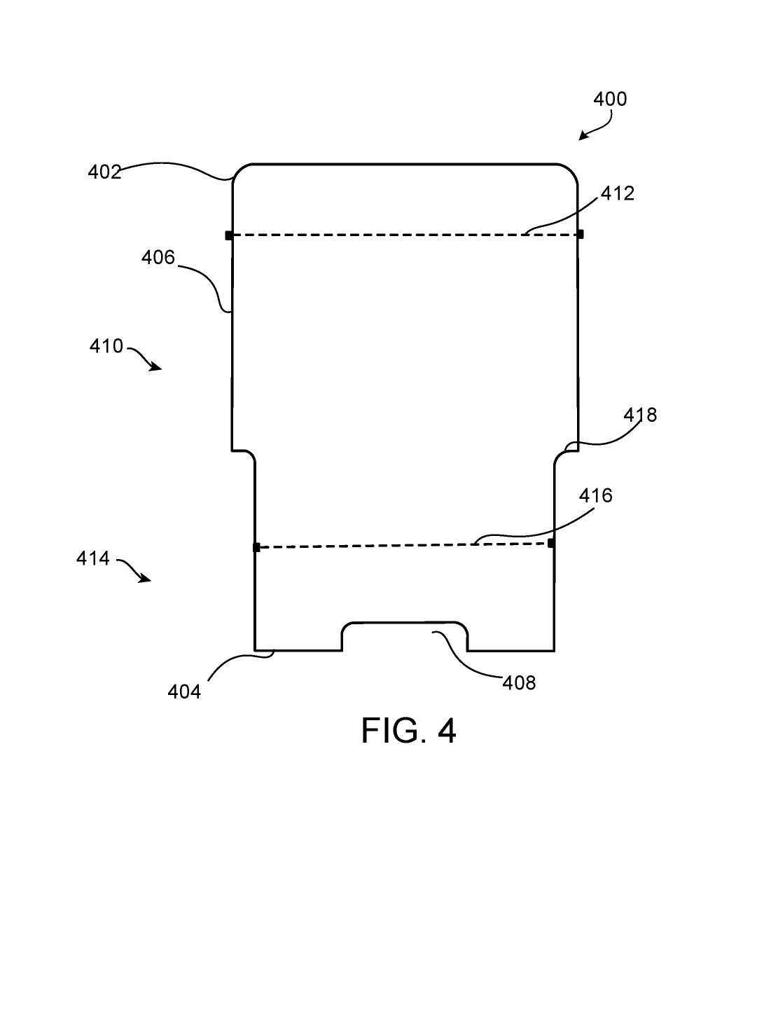

FIG. 4 illustrates a transparent display 400 that can be used with the pocket 200. The transparent display 400 includes a first end 402 and a second end 404. An external surface 406 includes a second shape that tapers from the first end 402 towards the second end 404. This second shape corresponds to the first shape of the pocket 200, enabling the transparent display 400 to be positioned in the pocket 200.

The transparent display 400 includes a second recess 408 positioned at the second end 404. This second recess 408 is configured to be positioned on the protrusion 312 on the interior side of the base 308 when the transparent display 400 is positioned in the pocket 200.

The transparent display 400 includes a third portion 410 having a third width 412 and a fourth portion 414 having a fourth width 416. The fourth width 416 is smaller than the third width 412. The third width 412 corresponds to the first width 324 of the pocket 200, and the fourth width 416 corresponds to the second width 326 of the pocket 200.

The transparent display 400 includes a pair of shoulders 418 separating the third portion 410 and the fourth portion 414. Each shoulder 418 tapers from the third width 412 to the fourth width 416 on the external surface 406 to define the second shape.

The first width 324, second width 326, third width 412, and fourth width 416 are sized to correspond to a width of the shipping label 106 and to mitigate movement of the shipping label 106 within the cavity formed by the pocket 200 and transparent display 400.

In some embodiments, the pocket 200 is opaque to provide contrast and make the shipping label 106 more visible through the transparent display 400. The opaque nature of the pocket 200 enables it to also be a place labels are applied. This dual functionality allows the pocket 200 to serve not only as a background for enhancing label visibility but also as an additional surface for attaching supplementary labels or information related to shipping, handling instructions, or other relevant details.

Labels could be applied to the pocket 200 in various ways, both with and without the transparent display 400. When the transparent display 400 is present, labels could be inserted between the transparent display 400 and the pocket 200, creating a layered information display. Without the transparent display 400, labels could be directly applied to the exterior surface of the pocket 200 using adhesives, creating a dedicated labeling area. This method allows for easy updating or replacement of information as needed. The ability to apply labels directly to or in conjunction with the pocket 200 provides flexibility in organizing and displaying important information associated with the package or its contents, enhancing the overall functionality of the shipping label holder.

The pair of sidewalls 304, 306 and the base 308 are fastened to the exterior side of the wall 102 via a coupling mechanism 330. The coupling mechanism 330 can be stitching or an adhesive, providing a secure attachment.

A retention mechanism 332 is fastened to the lip 316 to removably couple the lip 316 to the exterior side of the wall 102 and secure the shipping label 106 inside the cavity. The retention mechanism 332 can comprise Velcro or an adhesive, allowing for easy access to insert or remove the shipping label 106 while keeping it secure during transit. However, the retention mechanism 332 can be any type of closure. For example, the retention mechanism 332 can be a button, clip, or zipper. These various types of retention mechanisms allow for access to insert or remove the shipping label while also keeping it secure during transit.

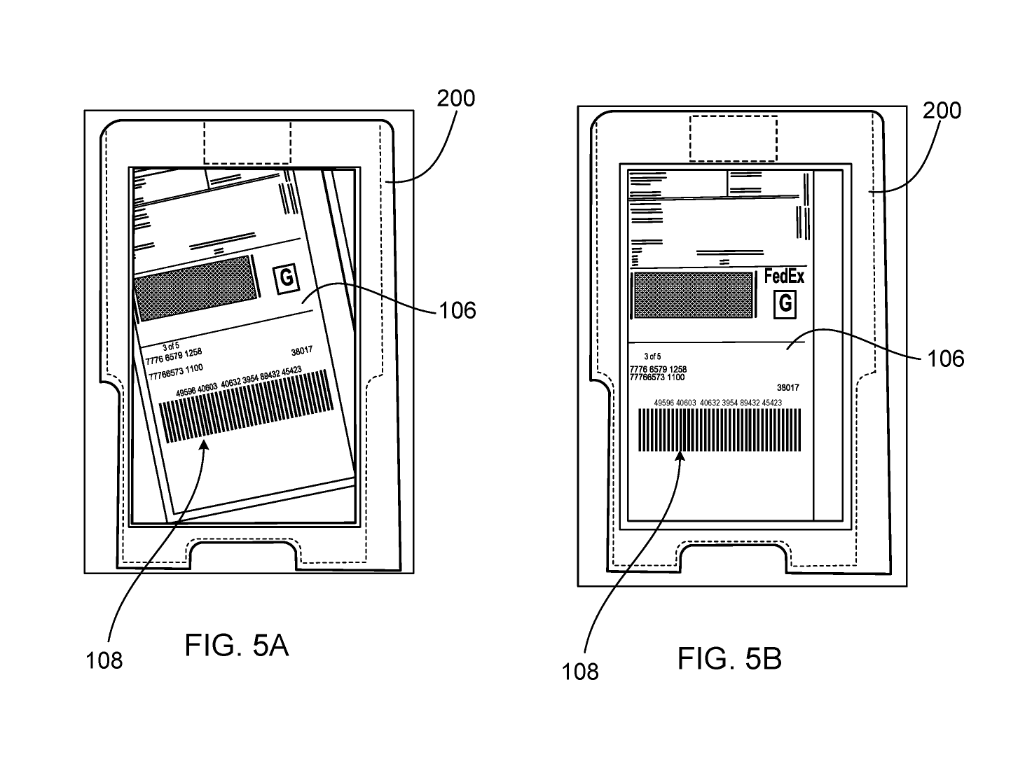

FIGS. 5A and 5B illustrate the document 106 inside of the pocket 200. As shown in the illustrated embodiments, the information 108 of the document 106 is visible and therefore accessible by individuals or machines that need to access the information 108 to process the shipping container 100 during a delivery process.

However, the implementations disclosed herein have broad applicability across various stages and components of supply chain management, extending beyond transportation. For example, the implementations disclosed herein an be effectively implemented in diverse settings such as storage facilities, shelving units, warehouses, distribution centers, and throughout logistics networks. The adaptability of this solution allows for seamless integration into existing infrastructure, enhancing efficiency and information accessibility at multiple points in the supply chain. For example, in a warehouse setting, the system can be applied to organize and track inventory on shelves, enabling quick location and retrieval of items. In distribution centers, it can streamline the sorting and routing of packages, reducing processing time and errors. The flexibility makes it valuable in static storage environments and dynamic transportation scenarios, providing a unified approach to information management across the entire supply chain ecosystem.

The accessibility of information 108 as shown in the illustrated embodiments is particularly important in fast-paced logistics environments where quick decision-making is essential. It allows for immediate verification of shipping details, routing instructions, or special handling requirements without the need to remove the document from its protective enclosure. This feature not only speeds up processing times but also reduces the risk of document loss or damage, maintaining the integrity of the shipping information throughout the supply chain.

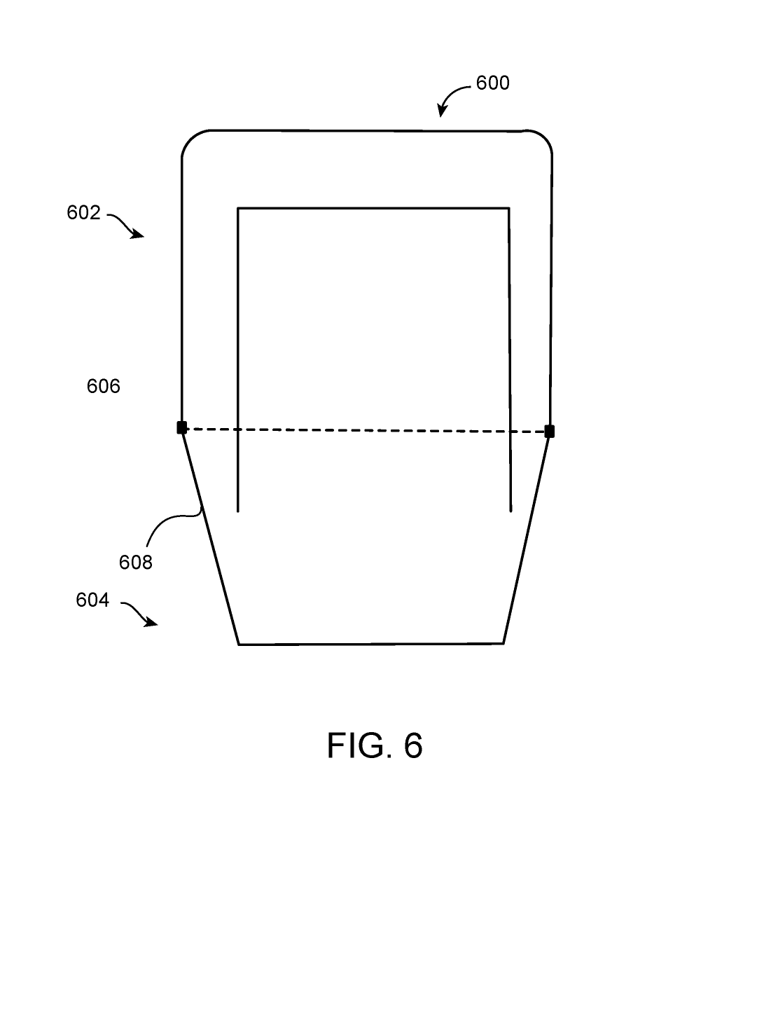

FIG. 6 illustrates an alternate pocket 600 that can be utilized instead of pocket 200 illustrated in FIG. 3. The pocket 600 includes a first portion 602 and a second portion 604. Instead of the pair of shoulders 328 as in the pocket 200 of FIG. 3, the pocket 600 includes a pair of tapers 606 on either side of the pocket 600 that transition to angled surfaces 608. The angled surfaces 608 mitigate movement of the document 106 (e.g., shipping label) during transit of a delivery process.

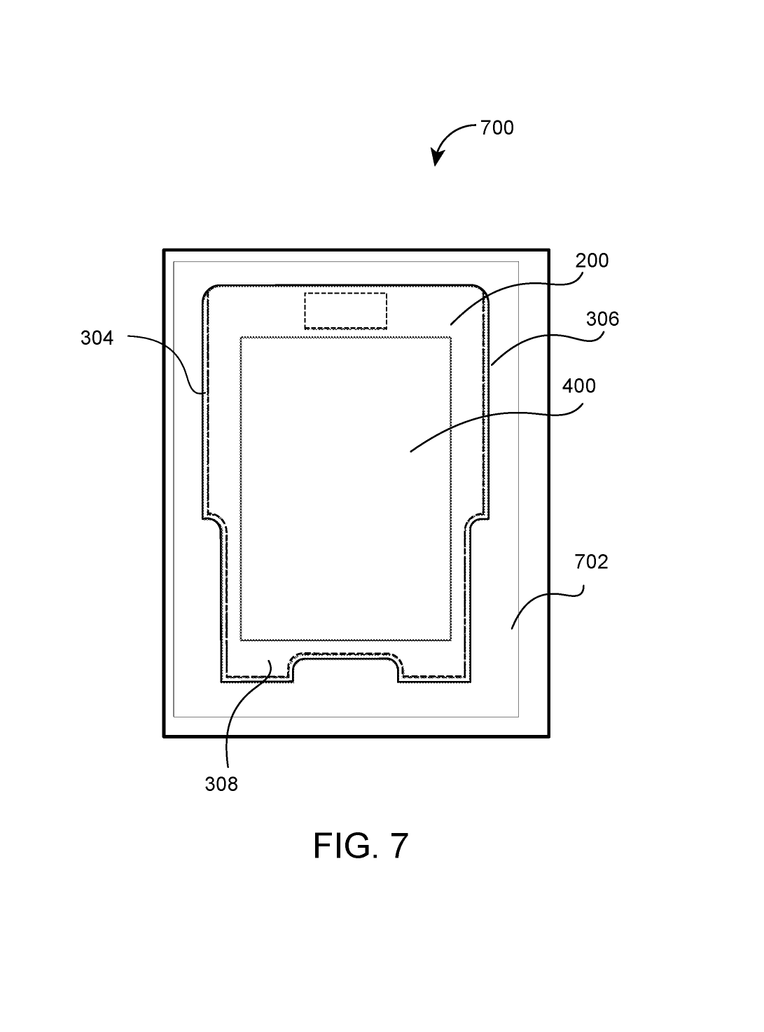

FIG. 7 illustrates a kit 700 that can be utilized in implementations disclosed herein. The kit 700 includes the pocket 200, the transparent display 400 and a temporary package 702. The rear surface of the pair of sidewalls 304, 306 and the rear surface of the base 308 include means for coupling to couple the pocket 200 to the temporary package 702. The temporary package 702 and the pocket 200 define a cavity to house the transparent display 400. The means for coupling can be an adhesive, providing a secure but removable attachment. The pocket 200 and the transparent display 400 are configured to be removed from the temporary package 702 and coupled to a shipping container 100, allowing for versatile use of the document centering system.

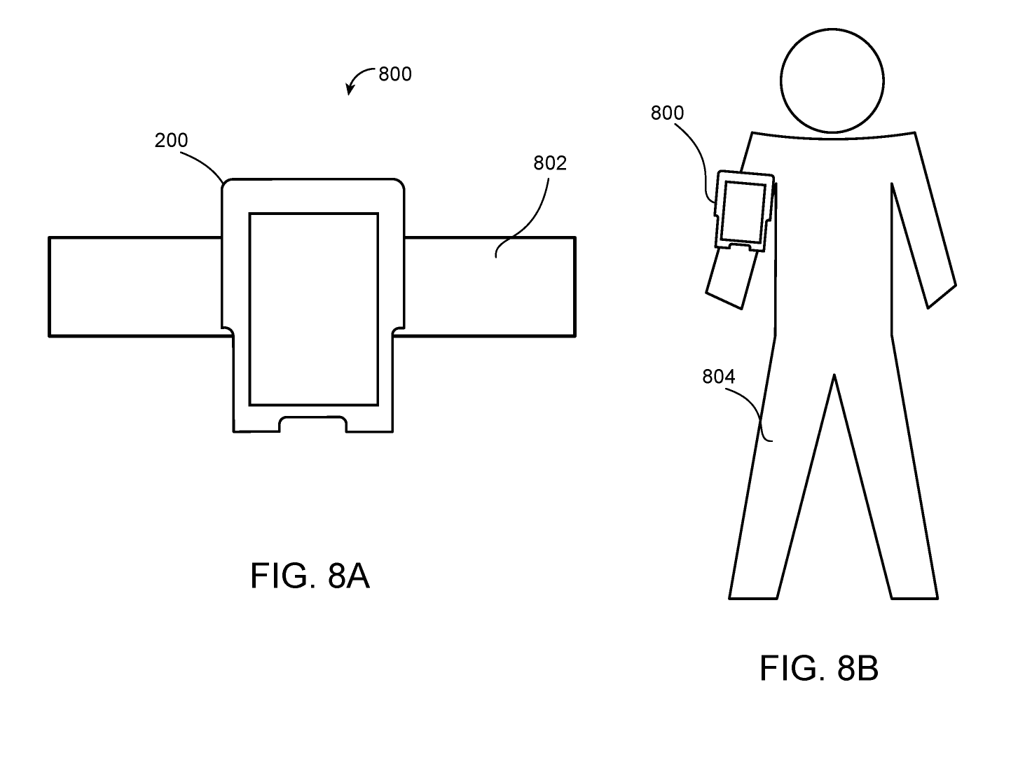

FIG. 8A illustrates an apparatus 800 for the pocket 200. In the illustrated embodiment of FIG. 8A, the pocket 200 is coupled to an armband 802. The armband 802 can be worn by a user 804 as shown in the implementation of FIG. 8B, where the user 804 is wearing the apparatus 800 on their arm. The apparatus 800 can be coupled to a lanyard or worn on other parts of the user's 804 body to display the document 106 (e.g., label, ski pass, identification card, etc.). This demonstrates the versatility of the document centering pocket, which can be adapted for various uses beyond shipping containers. For example, the pocket 200 can be integrated into stock shelf label holders in retail environments. This implementation would allow for easy insertion, removal, and automatic centering of price tags, product information, or promotional materials on store shelves, ensuring a neat and organized appearance while facilitating quick updates to displayed information.

In a broader context, the pocket 200 can be utilized in various label holder applications across different industries. For example, in warehouses or manufacturing facilities, the pocket could be attached to storage bins, equipment, or workstations to hold and display important information such as inventory details, safety instructions, or operating procedures. The self-centering feature would maintain a professional appearance and improve readability, even in fast-paced environments where labels are frequently changed.

The pocket 200 can also be utilized in the design of crates or containers for transportation and storage. By incorporating the pocket 200 into the sides or lids of crates, shipping companies or logistics providers can easily insert and update shipping labels, contents lists, or handling instructions. The self-centering mechanism would ensure that these critical documents remain visible and properly positioned, regardless of the crate's orientation or the document's size variations.

These diverse applications highlight the pocket's potential to improve organization, efficiency, and information display across various industries and use cases, extending far beyond its initial conception for shipping containers.

It will be understood that various modifications may be made. For example, other useful implementations could be achieved if steps of the disclosed techniques were performed in a different order and/or if components in the disclosed systems were combined in a different manner and/or replaced or supplemented by other components. Accordingly, other implementations are within the scope of the disclosure.

1. A document centering pocket comprising:
a base layer of material;
a pocket frame attached to the base layer of material along a first side edge, a second side edge, and a bottom edge of the pocket frame with a top edge of the pocket frame un-attached to the base layer of material, the pocket frame defining a central aperture therethrough, and
wherein the first side edge and the second side edge each comprises opposing indented regions where the pocket frame narrows such that a distance between an outer perimeter of the pocket frame and an inner edge of the central aperture is less than in other regions, and
wherein the opposing indented regions serve to center a document within the central aperture between the first side edge and the second side edge.

2. The document centering pocket of claim 1, wherein the bottom edge comprises a third indented region.

3. The document centering pocket of claim 1, further comprising a removable plastic cover configured to fit within the pocket frame such that a perimeter region of the removable plastic cover is captured between the base layer of material and the pocket frame, wherein the removable plastic cover comprises opposing indented regions that correspond with a shape of the opposing indented regions of the pocket frame.

4. A shipping container, comprising:
a wall including an interior side and an exterior side;
a pocket including:
a first end and a second end;
a pair of sidewalls, each of the pair of side walls extending from the first end to the second end, the pair of sidewalls fastened to the exterior side of the wall;
a base positioned at the second end, the base positioned between the pair of sidewalls to define a perimeter of the pocket, the base fastened to the exterior side of the wall, the base including a first recess that defines a protrusion on an interior side of the base;
a lip positioned at the first end of the pocket, the lip configured to be removably coupled to the exterior side of the wall;
an internal surface defined by the pair of sidewalls and the base, the internal surface including a first shape that tapers from the first end towards the second end of the pocket; and
an opening defined by the pair of sidewalls, the base, and the lip;
a transparent display including:
a first end and a second end;
an external surface including a second shape that tapers from the first end towards the second end, the second shape corresponding to the first shape to enable the transparent display to be positioned in the pocket; and
a second recess positioned at the second end of the transparent display, the second recess configured to be positioned on the protrusion on the interior side of the base when the transparent display is positioned in the pocket; and
wherein the exterior side of the wall, the pocket, and the transparent display define a cavity, the cavity configured to house a shipping label, the transparent display configured to enable information on the shipping label to be visible.

5. The shipping container of claim 4, wherein the pocket includes a first portion and a second portion, the first portion having a first width and the second portion having a second width, wherein the second width is different than the first width.

6. The shipping container of claim 5, further comprising a pair of shoulders separating the first portion and the second portion, each shoulder tapering from the first width to the second width on each of the pair of sidewalls to define the first shape.

7. The shipping container of claim 6, wherein the transparent display includes a third portion having a third width and a fourth portion having a fourth width, the fourth width being smaller than the third width.

8. The shipping container of claim 7, wherein the third width corresponds to the first width, and the fourth width corresponds to the second width.

9. The shipping container of claim 7, wherein the transparent display includes a pair of shoulders separating the third portion and the fourth portion, each shoulder tapering from the third width to the fourth width on the external surface to define the second shape.

10. The shipping container of claim 7, wherein the first width, second width, third width, and fourth width are sized to correspond to a width of the shipping label and to mitigate movement of the shipping label within the cavity.

11. The shipping container of claim 4, wherein the pocket is opaque.

12. The shipping container of claim 4, wherein the pair of sidewalls and the base are fastened to the exterior side of the wall via stitching or an adhesive.

13. The shipping container of claim 4, further comprising a retention mechanism fastened to the lip to removably couple the lip to the exterior side of the wall and secure the shipping label inside the cavity.

14. The shipping container of claim 11, wherein the retention mechanism comprises Velcro or an adhesive.

15. A shipping label display, comprising:
a pocket including:
a first end and a second end;
a pair of sidewalls, each of the pair of side walls extending from the first end to the second end;
a base positioned at the second end, the base positioned between the pair of sidewalls to define a perimeter of the pocket, the base including a first recess the defines a protrusion on an interior side of the base;
a lip positioned at the first end of the pocket;
an internal surface defined by the pair of sidewalls and the base, the internal surface including a first shape that tapers from the first end towards the second end of the pocket; and
an opening defined by the pair of sidewalls, the base, and the lip;
a transparent display including:
a first end and a second end;
an external surface including a second shape that tapers from the first end towards the second end, the second shape corresponding to the first shape to enable the transparent display to be positioned in the pocket; and
a second recess positioned at the second end of the transparent display, the second recess configured to be positioned on the protrusion on the interior side of the base when the transparent display is positioned in the pocket.

16. The shipping label display of claim 15, wherein the pocket includes a first portion and a second portion, the first portion having a first width and the second portion having a second width, wherein the second width is different than the first width.

17. The shipping label display of claim 16, further comprising a pair of shoulders separating the first portion and the second portion, each shoulder tapering from the first width to the second width on each of the pair of sidewalls to define the first shape.

18. The shipping label display of claim 17, wherein the transparent display includes a third portion having a third width and a fourth portion having a fourth width, the fourth width being smaller than the third width.

19. The shipping label display of claim 17, wherein the third width corresponds to the first width, and the fourth width corresponds to the second width.

20. The shipping label display of claim 17, wherein the transparent display includes a pair of shoulders separating the third portion and the fourth portion, each shoulder tapering from the third width to the fourth width on the external surface to define the second shape.

21. A kit comprising:
a pocket including:
a first end and a second end;
a pair of sidewalls, each of the pair of side walls extending from the first end to the second end, the pair of sidewalls including a front surface and a rear surface;
a base positioned at the second end, the base positioned between the pair of sidewalls to define a perimeter of the pocket, the base including a front surface and a rear surface, the base including a first recess the defines a protrusion on an interior side of the base;
a lip positioned at the first end of the pocket;
an internal surface defined by the pair of sidewalls and the base, the internal surface including a first shape that tapers from the first end towards the second end of the pocket; and
an opening defined by the pair of sidewalls, the base, and the lip;
a transparent display including:
a first end and a second end;
an external surface including a second shape that tapers from the first end towards the second end, the second shape corresponding to the first shape to enable the transparent display to be positioned in the pocket; and
a second recess positioned at the second end of the transparent display, the second recess configured to be positioned on the protrusion on the interior side of the base when the transparent display is positioned in the pocket;
a temporary package; and
wherein the rear surface of the pair of sidewalls and the rear surface of the base including means for coupling to couple the pocket to the temporary package, the temporary package and the pocket define a cavity to house the transparent display.

22. The kit of claim 21, wherein the means for coupling are an adhesive.

23. The kit of claim 20, wherein the pocket and the transparent display are configured to be removed from the temporary package and coupled to a shipping container.
